(19) United States
(12) Patent Application Publication
(10) Pub. No.: US 2009/0281908 A1
(43) Pub. Date: Nov. 12, 2009

(54) System for the Creation, Production, and Distribution of Music

(76) Inventor: Victor Wong, Austin, TX (US)

Correspondence Address: HEINZ GRETHER PC;G2 Technology Law, P.O. Box 40610, AUSTIN, TX, 78704, US

(21) Appl. No.: 12/324,084

(22) Filed: Nov. 26, 2008

Related U.S. Application Data
(60) Provisional application No. 61/004,304, filed on Nov. 26, 2007.

(51) Int. Cl. G06Q 30/00; G06Q 50/00

(52) U.S. Cl. 705/26

(57) ABSTRACT

The present invention provides a system for purchasing music in integrated songs or divided into manipulatable components and then create new works with these components in unique productions and then release and distribute such music in either integrated or non integrated form stored with information that tracks the relative royalty characteristics of the stems/components of the song for later accounting and distribution of royalties to the owners of the song/song components/stems based on the purchase reproduction and resale of the components/stems/songs.

### RELATED APPLICATION

The present invention is a continuation of and claims priority to Provisional application No. 61/004,304 filed on Nov. 26, 2007 the contents of which are incorporated herein by reference.

### TECHNICAL FIELD OF THE INVENTION

The present invention generally relates to the creation, production and distribution of music. More specifically the invention relates computer tools for taking elements of sound from different sources assembling those sounds into a song and distributing the song and the proceeds of the sale.

### BACKGROUND OF THE INVENTION

The creation and distribution of music predates history. In its earliest known form music was likely generated by the human voice and simple instruments and its distribution was through performance to an audience. FIG. 1 illustrates this creation and distribution with the artist 12 singing accompanied by an instrument 14 player 16 by a fire 18 with an audience 20 listening The only copying was by through the artist's repeat performance from memory or by a previous listener's copying of the performance in another performance. FIG. 2 illustrates one of the audience member 20 performing the work they heard performed by the original performer 12 in FIG. 1 to a different audience 22.

Over time performers modified the original performances and created new performances from elements of the previous performance. Sometimes separately and sometimes in what we call a JAM session today. This method of creation of distribution of music continues today.

As writing was invented musicians came up with systems of creating written representations of a musical work, which today takes the form of what is commonly referred to as sheet music 27. The invention and its evolution of written representations of music created a new method of distribution of the music as illustrated in FIG. 3.

As time progressed, people endeavored to created new instruments which were tools with which to generate sounds to make music. Those endeavors continue today.

As our species became more sophisticated we created new ways to produce the music. Early producers of music were bandleaders and conductors 28 that assembled a band and gave them direction in order to assemble the music from multiple sources into a song or symphony or accompaniment for other forms of performance as illustrated in FIG. 4.

Before we learned how to truly record music we came up with different systems like music boxes 30 to automatically generate a song as illustrated in FIG. 5.

Like the creation of sheet music, the creation of music boxes which could be reproduced and distributed creating a new method for the distribution of music. Music boxes were improved so that different templates could be installed in a music box so as to play a different song. (not shown).

Music boxes evolved into recording systems that could actually create an article which when placed in a player could reproduce a likeness of the original sound. The phonograph 40 illustrated in FIG. 6 is an example of such systems. The first phonographs likely had cylinder recordings (not shown). Later these evolved into disc shaped recordings 42. Soon we learned how to reproduce a phonograph disk 42 and a new method of distribution of the music was created—the sale of recordings on a tangible medium. The most common of these mediums in modern times was a vinyl disk. These vinyl disks typically either contained multiple songs (albums) or single songs (singles).

Recording system and players have been greatly improved over the years. Particularly when the electronic capture of sound were created. The electronic capture of sound enabled new forms of recording media such as magnetic tapes which took several different forms such as one track compact cassettes and 8-track cassette tapes and in other sound formats 4-channel tapes for “hi-fi” applications. While in the past most electronic recordings were analog in nature today, most musical recordings are stored in a digital form. The progeny of vinyl disc recordings today are commonly referred to as Compact Disc, CDs or Audio CD. Over the years, music has been distributed in a variety of tangible media. FIG. 7 illustrates some of the more prominent media: albums 44, singles 46, Reel to Reel tape 48, 8-track tape 50, cassette tape 52, and digital CDs 54.

The electronic capture of sound not only enabled new forms of recording media it also enabled another new form of music distribution—radio and television broadcasts as illustrated in FIG. 8. Early broadcasts of were live such as illustrated in FIG. 8 with the artist 60 performing into microphone(s) 62 which converted the sound to and electric signal which was processed and converted to a wireless electromagnetic signal and broadcast over broadcast tower antennas 64 to receiver antennas 66 which converted the wireless electromagnetic signal to an electronical signal to radios 68 which converted the electrical signals back into sound for the radio or television audience 70.

The methods of recording and producing the music also evolved from the early band leaders and conductors. As illustrated in FIG. 9, producers 80 with the assistance of studio engineers 82 worked in increasingly sophisticated recording studios with increasingly sophisticated sound equipment 84 such as multitrack recorders to capture, sounds from artists 86 and manipulate and mix the sounds to produce master recordings which could be distributed through the distribution channels of the day—radio, television and vinyl and tape.

As the analog systems evolved sound capture systems which converted and recorded the sounds in a digital format computer technology is replacing multitrack magnetic tapes in the recording studio. Today, many of the tools used by music producers in a sophisticated sound studio are available in the form of hybrid equipment incorporating computer software.

The availability of the sound files on a computer 90 enabled a new method for the distribution of music. This method is commonly referred to as online music distribution, which involves downloading of music files over a computer network such as the Internet. There are many factors that have contributed to the growth of this form of distribution. One factor that motivates consumers to purchase online is that this form of distribution enables them to purchase just the song that they want rather than a whole album. FIG. 10 illustrates and example of a list of songs on an CD by the artist known as Prince. If purchased by CD the customer must purchase the CD with all of the songs. If purchased online the customer has the option of purchasing either one of the songs (for example—Black Sweat, Track 4), or a select list of the songs (for example—Black Sweat, Track 4; Love, Track 6; and The Word, Track 9) or all of the songs.

FIG. 11 illustrates the user interface similar to one offered by Apple of Cupertino, Calif. online song distribution application called iTunes. The navigation of this sight is well known. It includes general computer window controls 100, conventional audio play controls 102 forward 104 and reverse 106 and play 108. When selected the play control 108 converts to pause (not shown). A sound volume control 110 is provided. A control window 112 is provided which allows for individual alternative active displays such as progress in the song (not shown) or band response (not shown) in the song, or progress of a song download (not shown). The interface also provides controls 120 for showing different interface view options. A field is provided for entering search terms 122. A field 124 is provided for showing search results and navigational tools for finding desired songs or song collections and provides recommendations for songs which can be purchased. Another field 126 illustrates a list of collections which the user has available to play. Another field 130 shows the songs in a collection selected either as a result of a search, a collection from field 124 or 126. Various play-run options are provided to the user such as loop random and similar interface options are provided as are means for creating new collections called play lists. These applications also typically provide options modifying the play configuration commonly known as a equalizer which provides the user with an option of adjusting the volume content contribution of various frequency bands. Typically these applications also include and eject selection for ejecting content from the system which are available by some removable media storage such as a CD, or other removable/ejectable drive. There is a need for a new system for the creation and online distribution of music which both respects the rights of copyright owners and provides artists with the freedom to create musical works.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates live music performance;

FIG. 2 illustrates distribution of music via re-performance of a previous performance;

FIG. 3 illustrates distribution of music in a written form;

FIG. 4 illustrates production of music by a band leader or conductor;

FIG. 5 illustrates distribution of music via a music box;

FIG. 6 illustrates phonorecording music distribution

FIG. 7 illustrates other distribution recording formats;

FIG. 8 illustrates distribution of music via broadcast:

FIG. 9 illustrates a recording studio for production of music and computer recording and production of music;

FIG. 10 illustrates a typical Collection/listing of songs recorded on a or album;

FIG. 11 illustrates the user interface for a prior art online musical distribution application;

FIG. 12 illustrates the site map for an embodiment of a new online musical creation and distribution system

FIG. 13 illustrates a new user interface for the creation purchase, and creation and distribution of music;

FIG. 14 illustrates a play bar information and search fields and upload or record content from FIG. 13;

FIG. 15 illustrates the master track from FIG. 14;

FIG. 16 illustrates the a stem information and control frame from FIG. 13;

FIG. 17 illustrates a stem and control frame from FIG. 13;

FIG. 18 illustrates a listing of stems available from a single archived song;

FIG. 19 illustrates a user interface for manipulating individual stems of the song listed in FIG. 18;

FIG. 20 illustrates a new song creation from a number of purchased stems from multiple songs and unique artist stem(s);

FIG. 21 illustrates a user interface for manipulating individual stems of the new song with stems listed in FIG. 20;

FIG. 22 illustrates a user interface for logging in to save a work in progress, purchase stem song components, select a purchase/distribution option;

FIG. 23 is an illustration of biographical information for a new creation;

FIG. 24 is an illustration of an interface for the selection of purchase/distribution options;

FIG. 25 is an illustration of a preferred My Studio workstation for producing new content;

FIG. 26 is an illustration devices on which My Studio creative work could be performed and additional forms in which the results of the present system can be distributed.

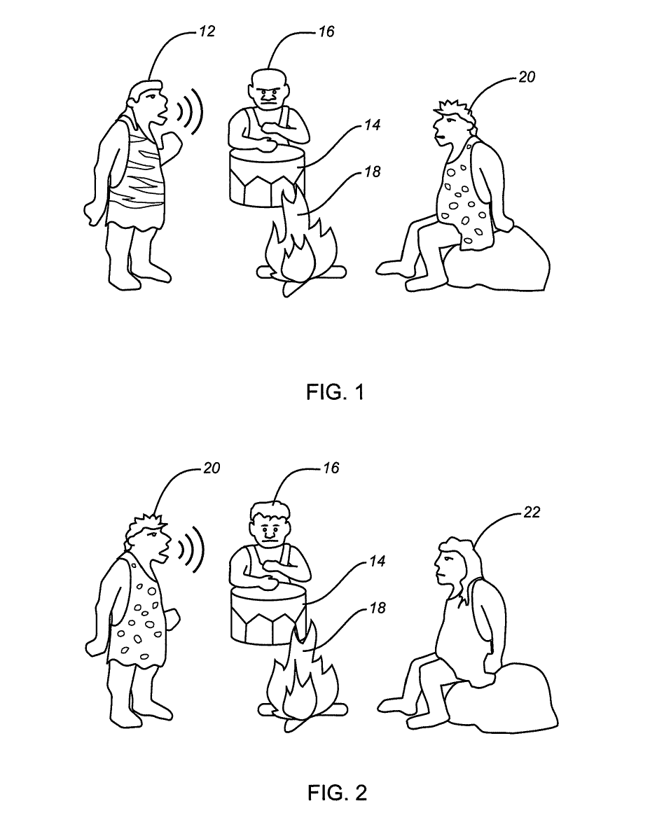

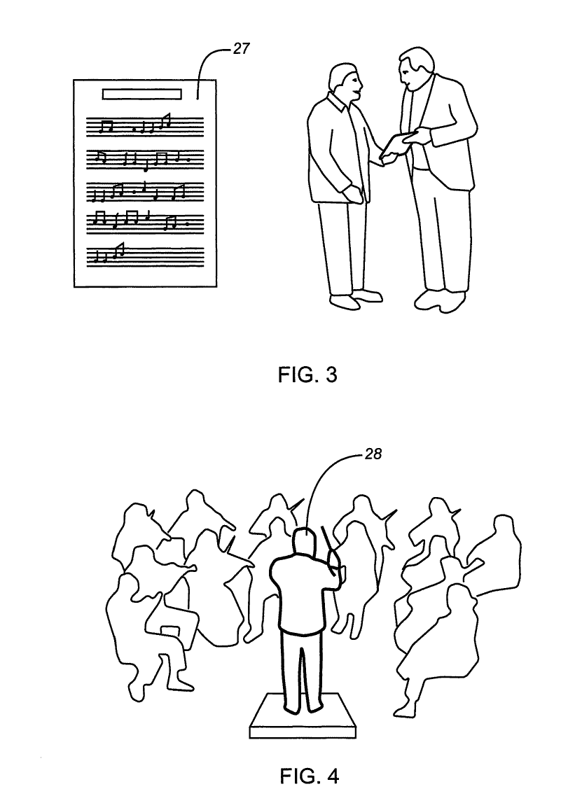

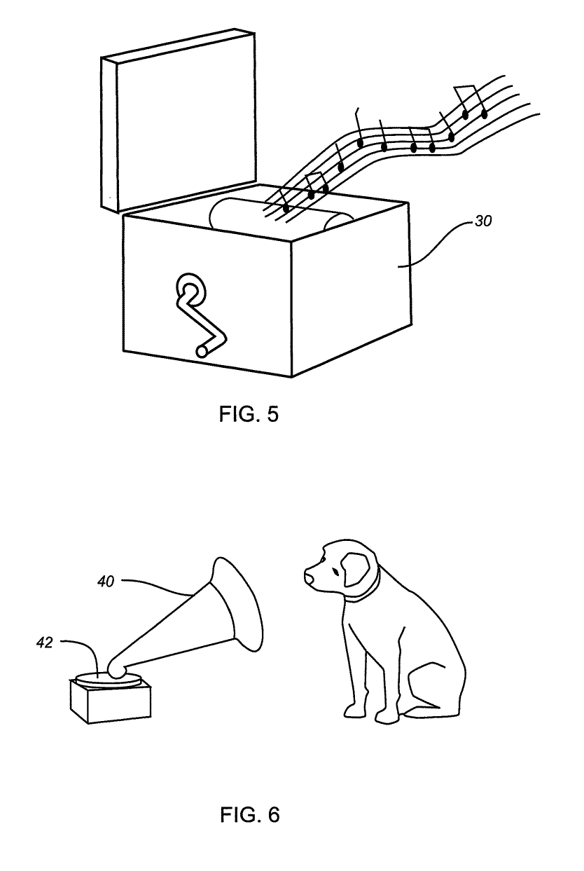

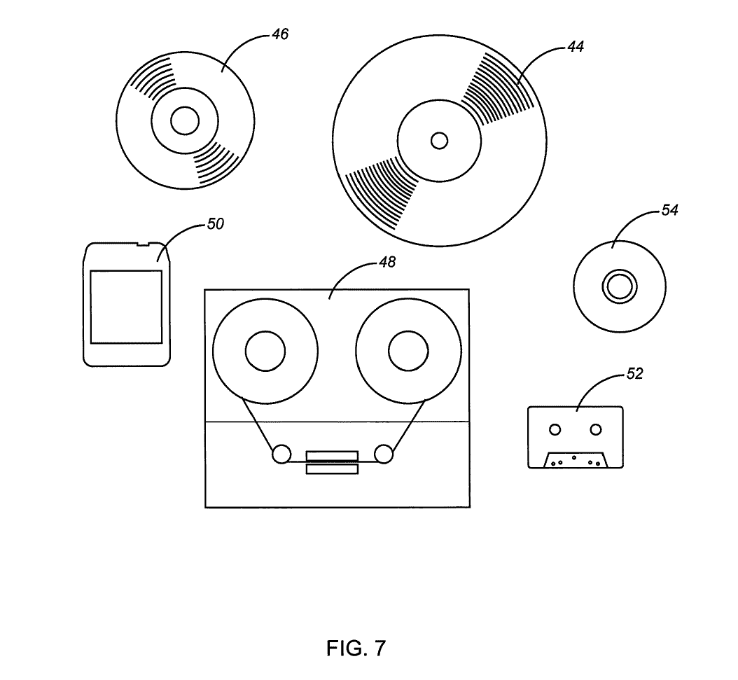

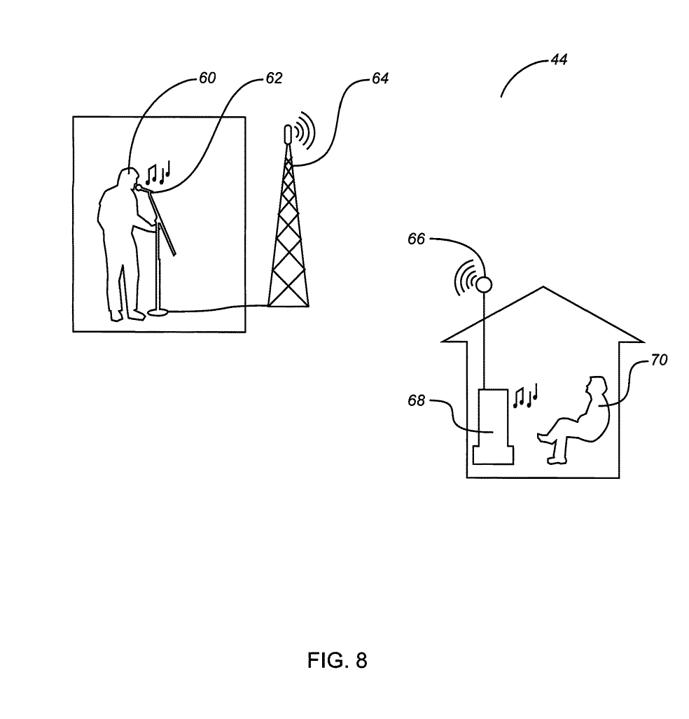

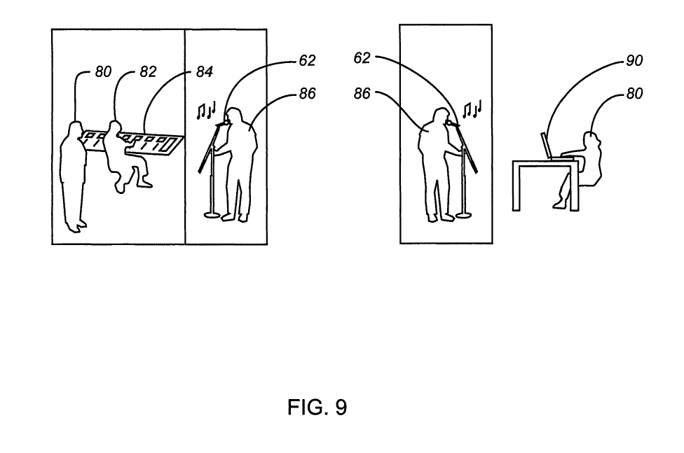

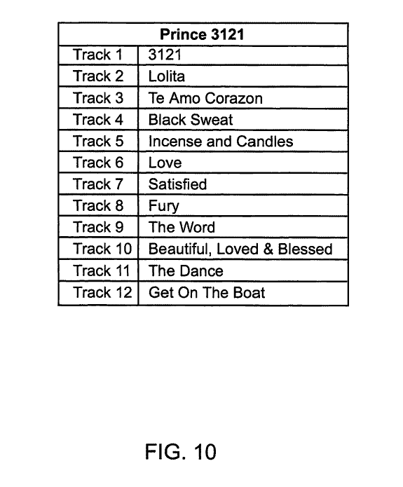

### DETAILED DESCRIPTION OF THE INVENTION

Preferred embodiments of the present invention are illustrated in the Figures, like numerals being used to refer to like and corresponding parts of the various drawings.

The present invention generally relates to the music creation and distribution systems and more specifically to online network or offline. The system disclosed provides smooth movement and reduces backlash in the movement to provide a system with high positional accuracy while mitigating the need for expensive high resolution encoders.

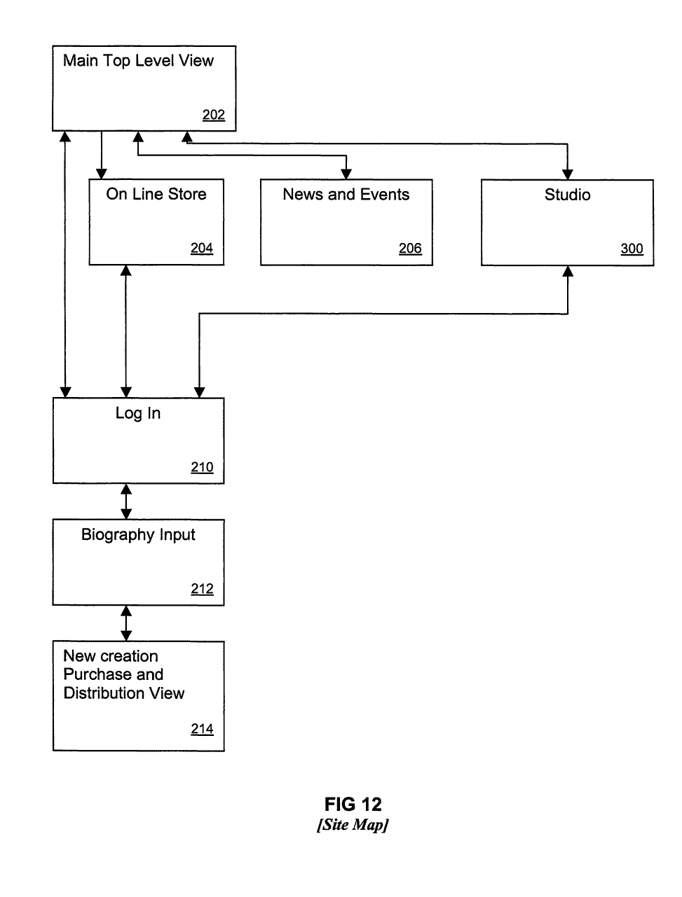

A interface mapping of one embodiment the present invention is illustrated in FIG. 12. The main top level home interface view 202 provides numerous links to other interface view including: an online store 204; a news and events interface 206 and a studio 300. In the mapping shown, most of these interface views provide the option of returning to the top level home interface view 202.

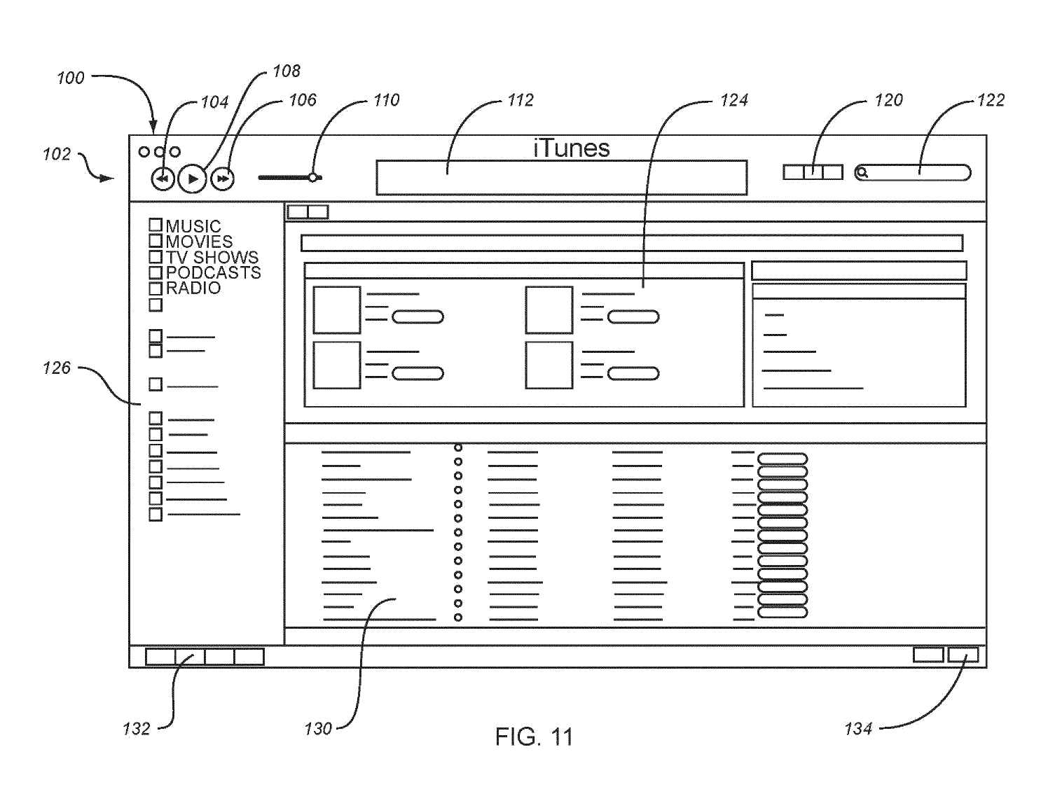

The on line store view 204 is similar to many other on line music store interfaces such as the one illustrated in FIG. 11. However this online music store includes songs which are not only available as integrated songs, but also, includes songs which are available so that individual stems from the song can be selected for manipulation in the studio 300. The news and events view 300 is similar to other online news and events interfaces providing the user with current news about artists tours, new releases, tours, and links to other music news sites and artist pages, and web logs. The page interface also provides search means to allow the user to search the new site generally, the site archives and the computer network generally. Though not show in this embodiment the online store 204 and news and events 206 view also provide a link to the Studio interface 300.

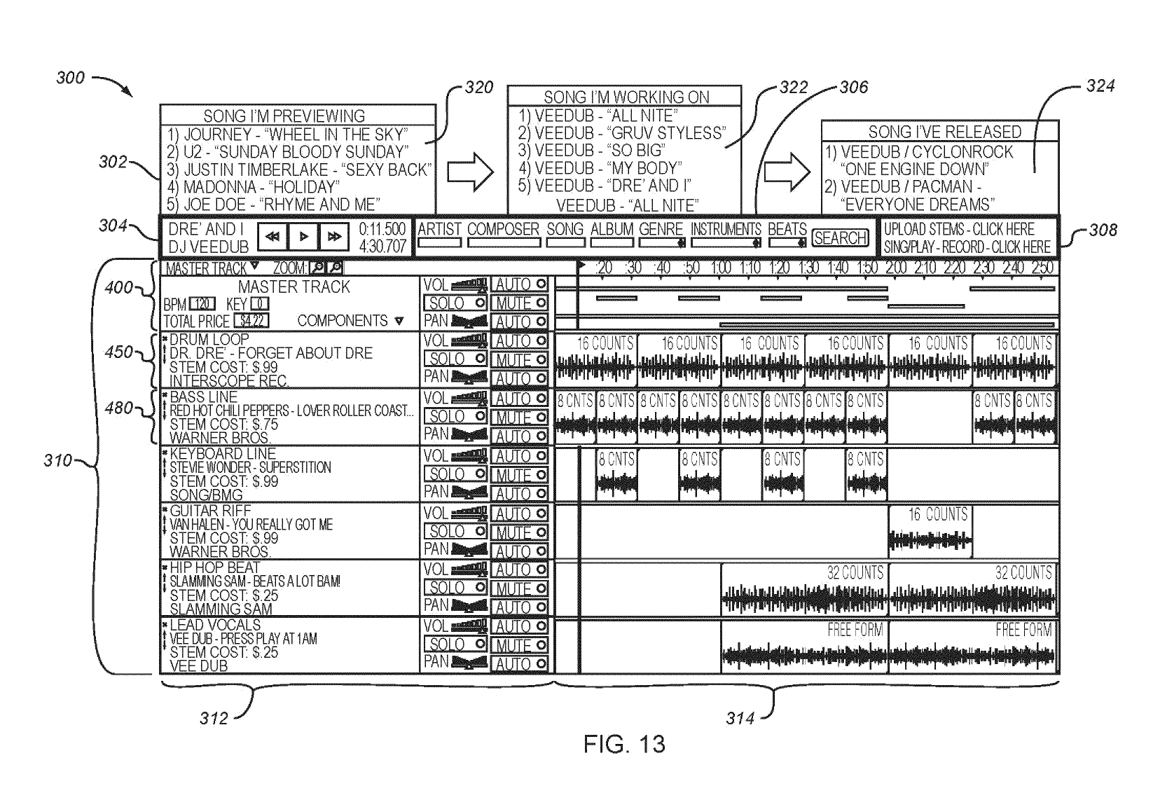

An embodiment of the Studio Interface 300 is illustrated in FIG. 13 and provides the user with new tools. The Studio Interface has several sections. On top is a song list section 302 that provides user specific lists. Below the song list section 302 is a play bar 304. Next to the play bar 304 is a biography identification section 306. Next to the biography identification section 306 is a section 308 which allows the user to upload songs or song stems from another source. Below the play bar 304 biography 306 and upload 308 sections is a section that lists the components or stems that comprise elements of the song and together make the song. The stem list 310 is comprised of two columns: one column 312 identifies the stems, and the second column 314 illustrates a timeline illustrating the activity of the stems in the song.

In the embodiment shown the song list section 302 is comprised of three parts containing three different lists of songs. The first section 320 is comprised of selected songs from the store archive. In alternative embodiments this section may include integrated songs, songs for which multiple stems can be individually manipulated, and individual stems. In yet other components, the list indicates which songs/stems have been purchased and which stems have not yet been purchased but which have been selected by the user from the online store 204 to be available in the studio 300.

The second list section 322 from the list section 302 contains a list of songs which are current projects of the user.

The second list section 324 from the list section 302 contains a list of songs which have been released by the user. In alternative embodiments this list distinguishes between songs which have been purchased for different levels or types of distribution. For example the song my be released in integrated form where the individual stems are not accessible to a purchaser, or they may be released in producer form where all of the stems are accessible and manipulatable in the users My Studio or the song may be release in a mixed formate where some but not all of the stems are accessible to the purchaser. The song may also be released so that it can be played streaming on a web player or on a dedicated player or on mobile devices such as a cell phone or as a ring tone.

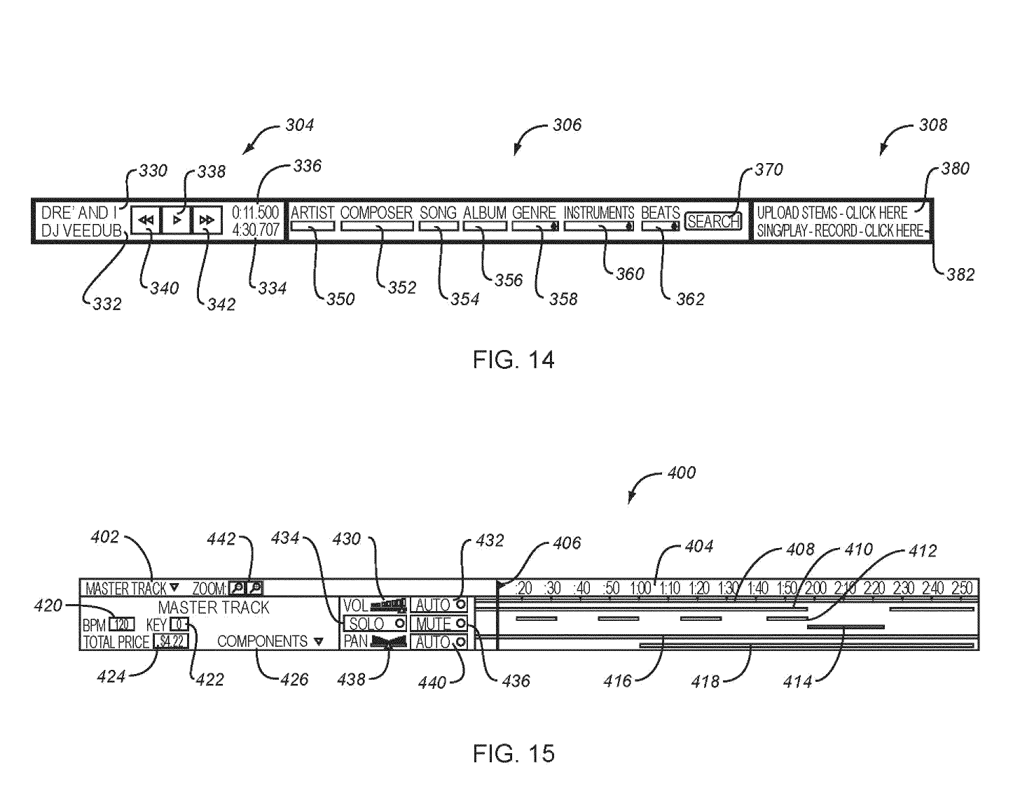

FIG. 14 illustrates sections 304, 306 and 308 from FIG. 13. Section 304 includes an identification of the song project 330 and the artist or band name 332. It also includes an indication of the song length 334 and the progress or current play location 336. The section also includes a play election 338 which toggles between play and pause. The play bar section 304 also includes fast forward 342 and fast rewind 340. Though not shown, in alternative embodiments these control elections include skip to beginning skip to end elections and other similar control options and indicators.

Section 308 includes a field which displays information for what ever track, stem or song is selected in section 302 or 310 and defaults to information about the song project selected in section 304. The fields include a field for: artist 350, composer 352, song title 354, album 356, genre 358, instrument 360, and beats 362 other fields may be included in other field or combination of fields. Section 308 serves a dual purpose. The user can also use a search tool by entering information in the subject fields 350, 352, 354, 356, 358, 360 and/or 362 and use the search button 370. When the search is elected the results are highlighted in the list sections 302, 320, 322, 324 and/or section 310.

FIG. 15 illustrates the Master Track 400 from FIG. 13. The master track includes a stationary section 402 and a moving section 404. Within the moving section there is a progress indicator 406 that indicates where in time progress the song is being played or worked on by the user. In typical use the progress indicator 406 moves to the center of section 404 and then stays there and the background moves until the end of the song appears on the end of section 404 and then progresses to the end of section 404 on the right side. The moving section 404 of the mater Track 400 includes indications 408, 410, 412, 414, 416 of the location of stem content for multiple stems.

The stationary section 402 of the master track 400 includes settings that can be selected by the user. The selections include setting the beat per minute (BPM) or play speed 420. In the illustration the BPM is set at 120 BPM. This is important because the stems are made available in multiple counts. In the illustration the beat count options are multiples of 8 counts: 16 counts, 24 counts 32 counts etc. The system also allows for free form content.

The user can also set the key 422. In the illustration the key is set at C. The master track also provides an indication of the current cost for the selected stems 424 which in the illustrated example the current total price for the stem components is $4.22. It also contains controls for the volume 430 and pan 438 which can both be set on auto 432 and 440 and mute. These controls serve as master controls for these functions. The master track 400 also has allowances for zooming in and zooming out 442 the size of the tracks.

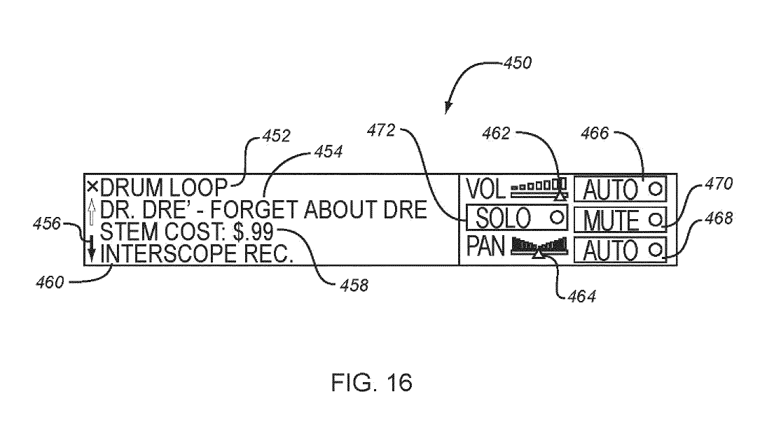

FIG. 16 illustrates the stationary title block for an individual stem 450 from FIG. 13. The title block 450 includes information about the type of stem 452. In this case the type is a “drum loop.” Many other types of stems are contemplated. The title block also includes the artist 454 and the name of the song 456—in this case “Dr. Dre” and “Forgot About Dre” respectively. The title block 450 also includes the price for purchase of the stem—in this case ninety-nine cents ($0.99) The title block 450 also includes the name of the record label or publishing house that owns the copyrights to the stem—in this case “Interscope Records”. In the embodiment shown the stationary title block also includes the same controls as are available for the master track but they only control that stem—in this case the drum loop stem. In this embodiment the controls include a volume slide control 462, pan slide control 464 auto modes for each 466 and 468 respectively and a mute election 470. If the mute election is selected the stem will not contribute sound when the rest of the song is played. In some embodiments, some or all of these the controls have time memory in other words if the volume control is set to high at the beginning of the song the stem is loud at the beginning of the song if the user sets the volume control lower in the middle of the song then the stem contributes less volume to the control in the middle of the song when the song is played back.

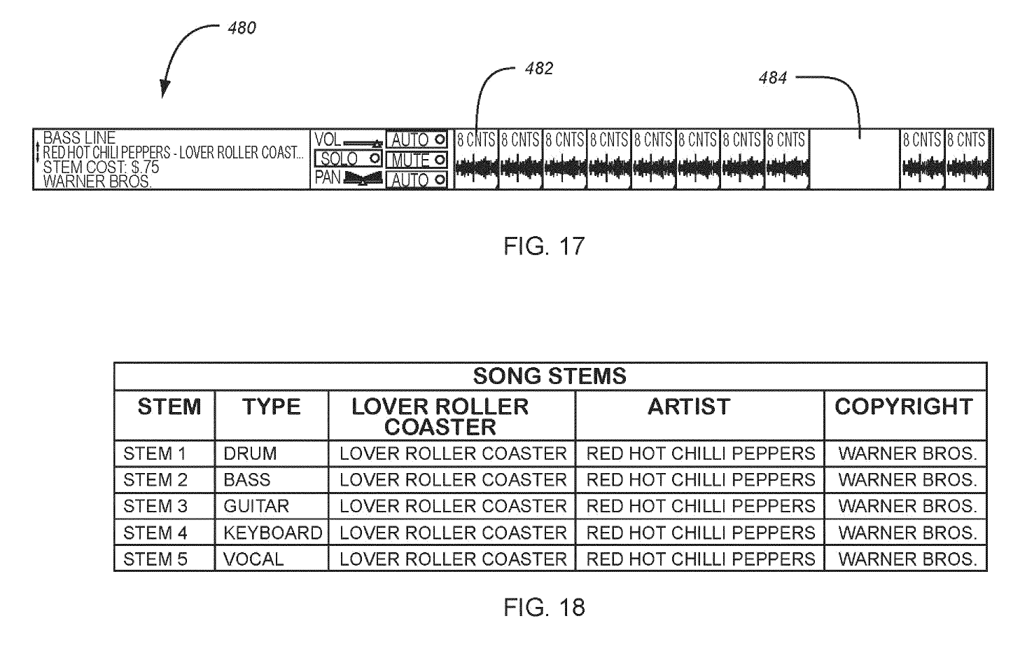

FIG. 17 illustrates another stem 480 from FIG. 13. In this case the stem is a Base Line from Lover Roller Coaster by the Red Hot Chilli Peppers owned by Warner Bros. with a cost of seventy-five cents ($0.75). Note that this stem has an 8 count 482 which in the portion of the song shown repeats itself 8 times is silent for 16 counts and then repeats again for 6 more times all at the users election.

FIG. 18 illustrates a listing of the stems available at the online store for the song from which the base line stem (stem 2 in the list) was taken to construct the song being created in the studio illustrated in FIG. 13. This listing is available at the online store. On the online store the song or individual stems may be sampled. Then the interface allows the user to either purchase the song or a stem or all the stems. The user may also elect to select them to be available in the online studio. In either case the selected or purchased content will be available in list 320 in the My Studio interface 300 illustrated in FIG. 13. If the material is only selected, but not purchased, the user may work with the material in My Studio 300 but he cannot down load his work or publish or distribute it without purchasing the selected stems used in the new creation.

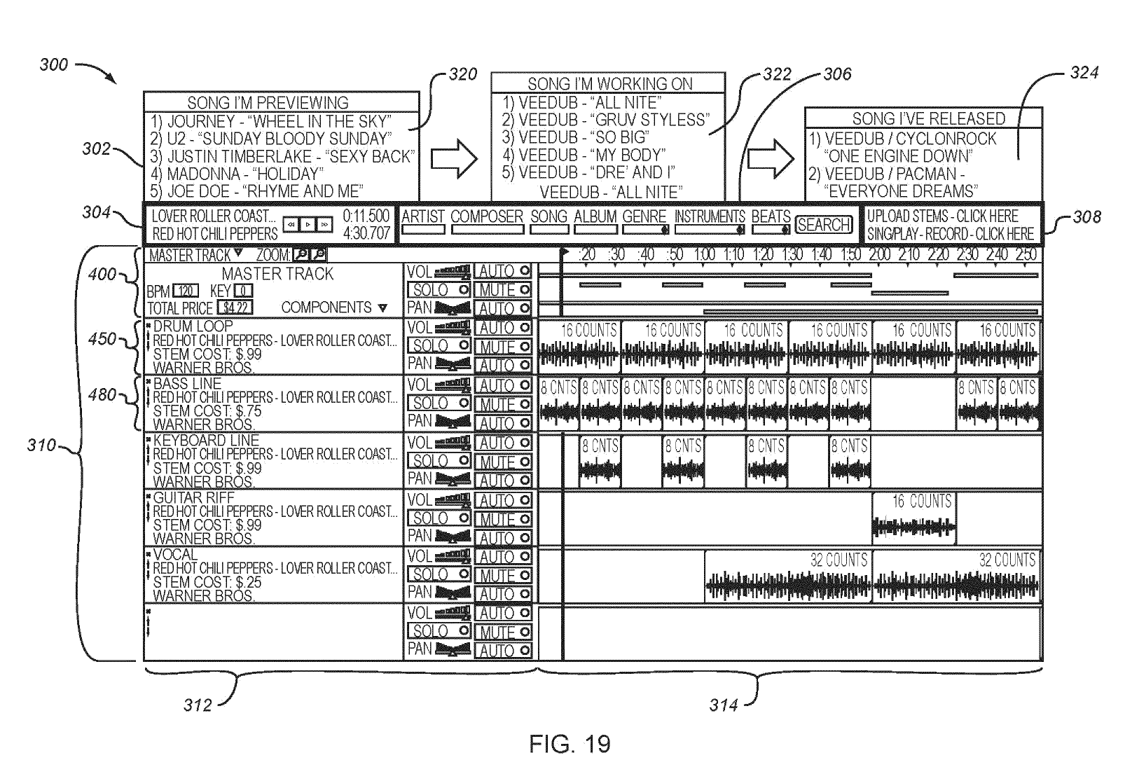

FIG. 19 illustrates an alternative view of controls available to the user for working with the stems. In this case the stems grid is for the stems available from the on-line store.

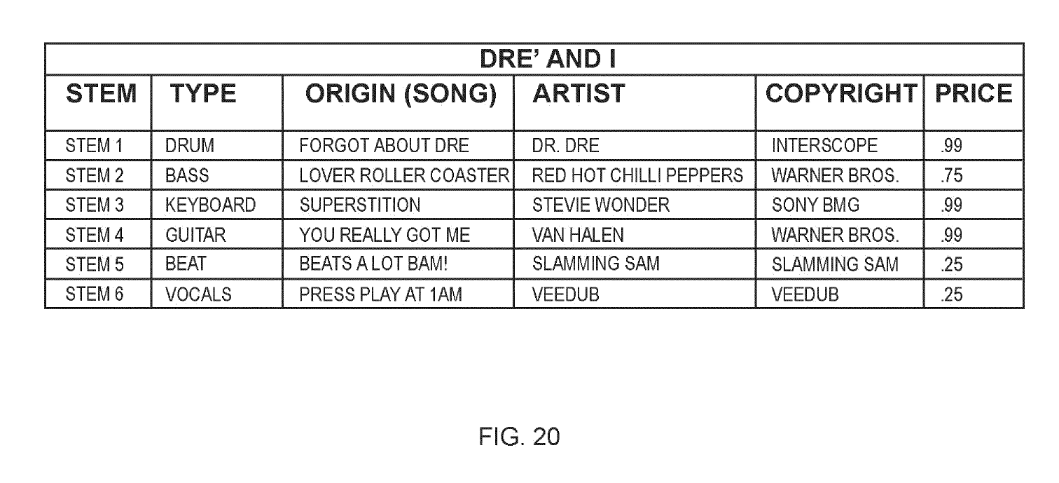

FIG. 20 is an illustration of a listing of the Stems that comprise the user creation that is the work in progress illustrated in FIG. 13. The song includes stems from different songs from different artists and includes a vocal stem added created by the user using the name VeeDub. Note that the price of the stems is indicated in the listing. Note also that the user has placed a price of twenty-five cents on the vocals stem the user created. This means that when the song is published for distribution, the individual stem will be available to other users for a price of twenty-five cents ($0.25).

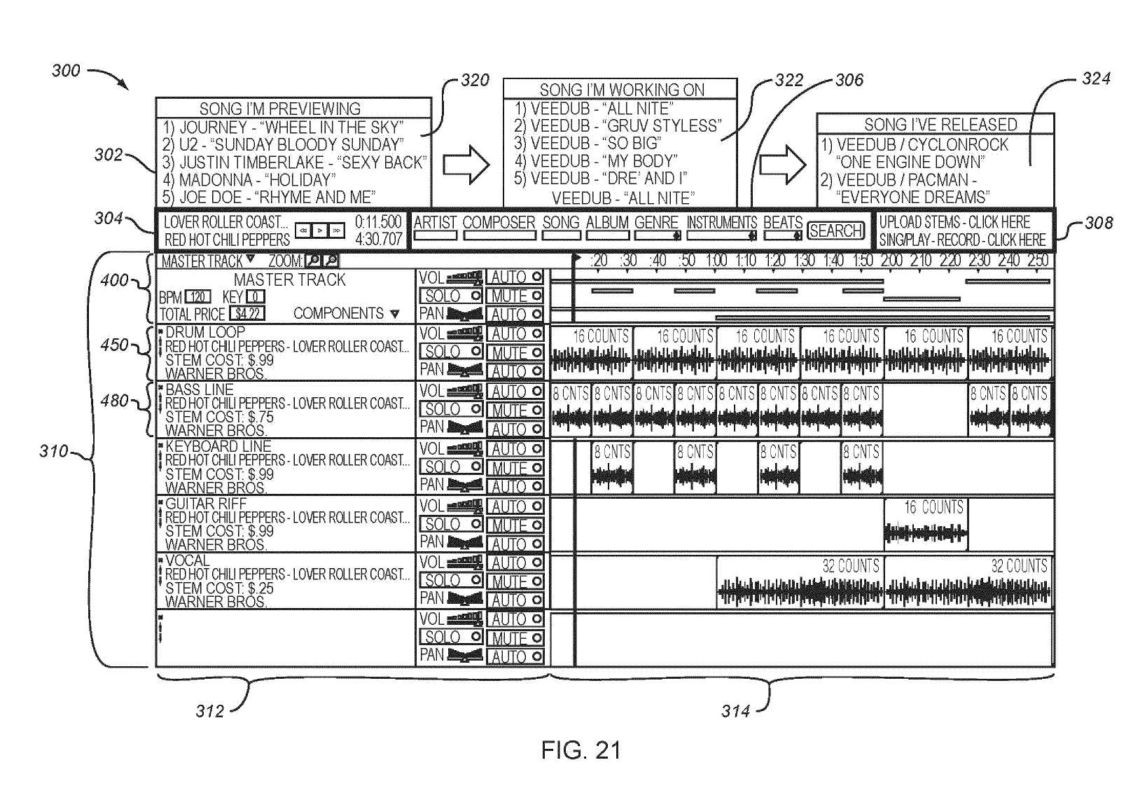

FIG. 21 illustrates an alternative view of the controls available to the user for working with the stems selected by the user for the project with components/stems listed in FIG. 20.

In the preferred embodiment the Studio interface 300 like the one illustrated in FIG. 13 also includes elections for “login” (not shown) and “buy” (not shown). If the user elects “login” or if the user has not logged in and elects “buy”, the user is taken to a login interface.

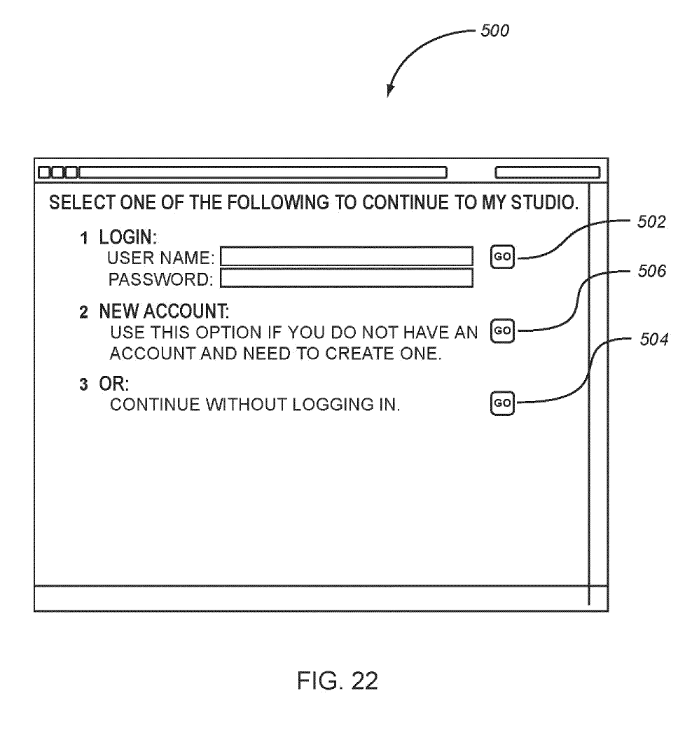

An embodiment of the login interface 500 is illustrated in FIG. 22. In the some embodiments the login interface 500 is available from multiple interfaces such as the main page, the online store in addition to the studio page. The user must login in 502 in order to purchase songs or stems and/or to publish a song and make it available at the online store, or distribute it through other means such as SMS to mobile devices, or to send text or voice or video messages to mobile devices, or networked computers burn discs or download to any other tangible media such as hard discs, nonvolatile memory devices such as flash that can serve as audio and or video players. In the embodiment shown, the login interface includes an indication of the Users previous location by indicating that after the login process is over the user will be returned to the My Studio interface or previous location. The login interface 500 also provides the user with the option 506 of creating a new account.

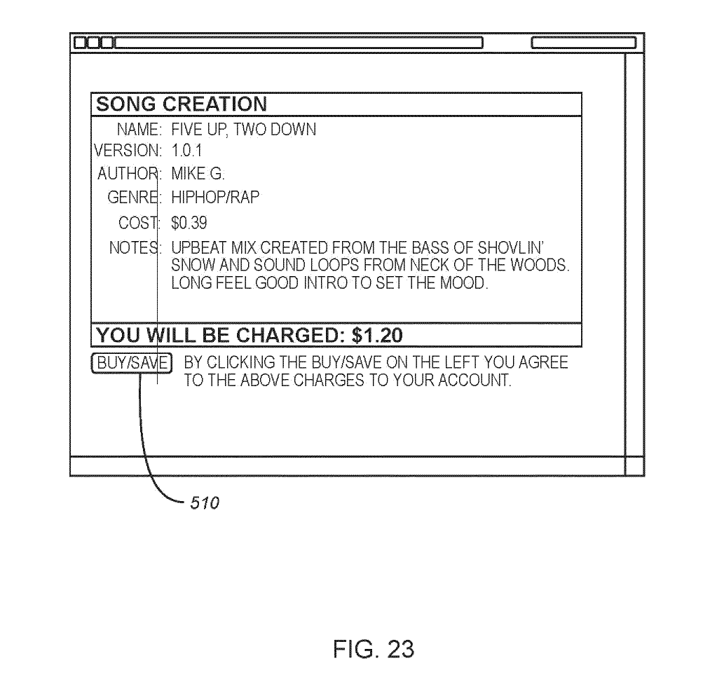

If the user is logged in and desires to purchase music or publish or distribute music, the user is presented with a user interface such as the one illustrated in FIG. 23. In this case the user seeks to purchase a Hip Hop/Rab stem by Mike G. for thirty-nine cents ($0.39). The user may complete the transaction by electing “buy/save” 510 which will take the user to a shopping cart page like those known in the art of online retailing.

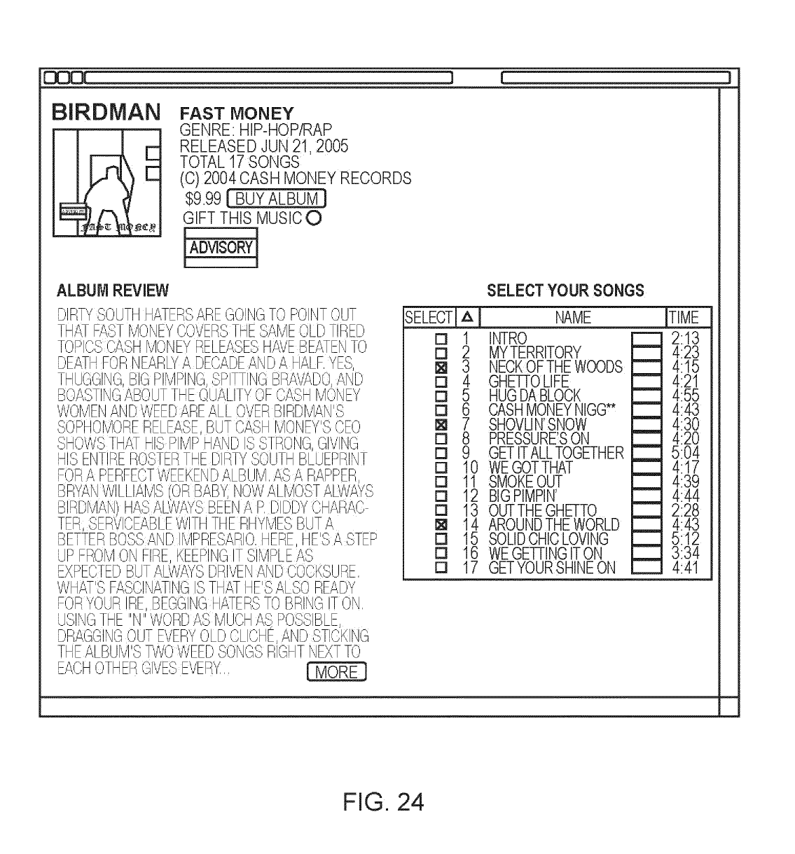

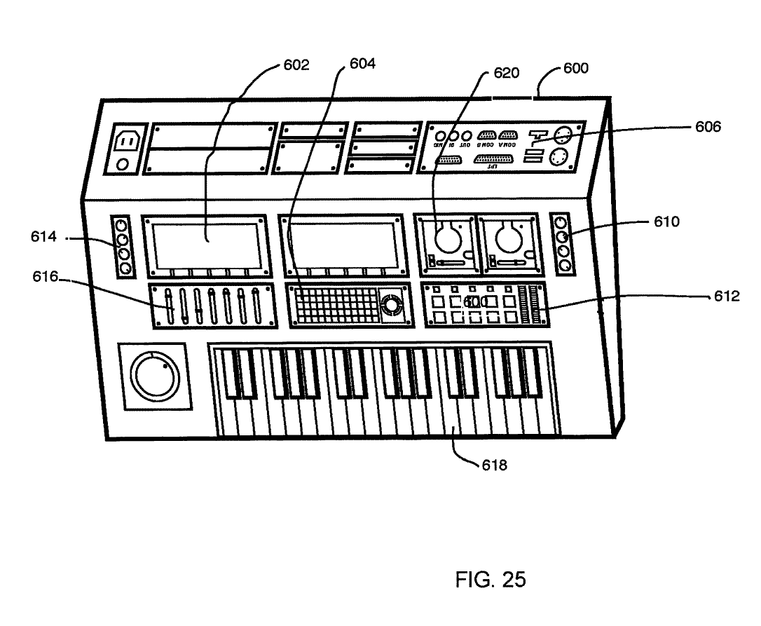

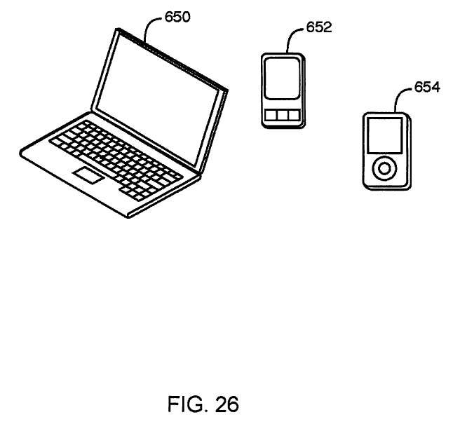

If the user wishes to publish a song or distribute the song, the user is presented with an interface like the interface illustrated in FIG. 24. However the user is provided with the option of modifying the bibliography information about the song and or stems being published. The user is also provided with a myriad of options for how the user wants to publish and distribute the song. The song can be published just for the users use. It can also be published for others to purchase on the on-line store. The user can set a price subject to licensing minimums set for the redistribution price of stems included in the song. For example the Dre Beat may be available for ninety nine cents to be used in the Studio published song but the price for distributing an integrated song with the Dre beat included may have a minimum price of nine cents ($0.09).

In summary the present invention provides users with the ability to take music stems, parts of stems, loops, beats, etc from a published/released song and combined it with other published/released songs in real time online via a client-side software or via a web browser based interface. It provides users with the ability to search for stems or loops by artist name, song title, album name, bpm, key, genre, etc online via a client-side software or via a web browser based interface.

It provides the Ability to arrange and rearrange the stems, loops, beats, etc in real time via a client-side software or via a web browser interface to create songs and have it play back in real time and to sing or play along the song being created and have the singing or instrument being played be recorded into a track or tracks in real time and be added as part of the song being created.

The Studio interfaces provide the ability to assign audio effects in real time to the singing or playing that is being recorded in real time into the song being created using pre-defined settings such as: reverb low, reverb med, reverb high or delay low, delay med, delay high and also to stems, loops or beats.

The publish/distribute interface allows the user to assign a royalty amount to stems, loops, beats, etc as well as uploaded audio and video files created by the user subject to minimums set by similar components that were incorporated in the work from the on-line store.

As the song is being created, each stem, loop or beat, will carry with it the data as described pricing parameters and bibliography information about the component. Using the data, the system automatically lock the PARTS (hereby noted as stems, loops or beats) into the project timeline for the song being created including but not limited to: bpm, key, etc. . . . allowing for simple drag and drop of each of the pieces of the PARTS into the project timeline to create the song, once the master bpm, key and other options have been selected for the song being created.

The server(s) processing the creation of the songs will operate in two different modes during the song creation process. (1) During the real-time construction of the song by drag and dropping the PARTS into the project timeline, the server(s) and system will simply PLAY the parts as it would play any audio file, in the proper sequence. The parts will not be mixed or edited together as it would be in a completed song. (2) Once the user creating the song is finished with the song, and indicated to the server(s)/software to this effect, the server(s) and software will take all of the PARTS, along with any sing along or play along parts and any uploaded parts, all with any specified audio effects and combine via mixing, remixing, rendering or any other appropriate process to create a contiguous audio file, which is the exact structure, tone and sonic copy to the PLAY only version.

At the time that the newly created song is readied by the server(s)/software, the total amount of each of the PARTS will be summed and presented to the user. This will be the price for the song that the user has just created.

When the user pays for the newly created songs via an account, cc, or other payment methods, the revenue will be automatically credited to the account(s) or transferred to each of owners of each of the PARTS as per the royalty attached to each PART. This amount may be net of processing fees for credit processing and Server fees.

There is no limit to the number of times a PART can be used and each time it is used, it will go through the process as described above and will be paid as stated above after each use. In some embodiment the charge for using the stem depends on the extent of the use of the stem in such song. Also taking into account the other stems and the extent of their use in the song.

Once the song has been paid for and created by the server(s)/software, the user will be provided three things: (1) A copy of the song for their listening pleasure in MP3, WAVE or any other audio format, (2) software code or other technologies that will allow the user to propagate the HitStems audio/video player, (3) instant listing of the newly created song within HitStems online or other audio/video download, listening, streaming or commerce site and allow the creation to be burned to CD ROB disk or other volatile or non-volatile media such as hard discs, nonvolatile memory such as flash drives or in audio file players such as MPG players 654 or mobile phones 652 or lap top 650 or desk top computers 600 or computer servers 600.

The system code or other technologies which will invoke the HitStems audio/video player will allow the user to promote, share and sell his songs or videos. The user can place the software code or other technologies into any website, webpage, email, instant message, mobile phone application, chat, online role playing site, computer games, video games, second life/virtual environment, etc and have the HitStems player be shown and accessible by others using, viewing or exploring the listed sites, applications, etc. . . .

The HitStems player will consisted of the following parts: (1) The ability to show a song or video's information as detailed in #8, (2) The ability to show a single song and or video or multiple number of songs and or videos, (3) The ability for the viewer, public, etc. . . . to select a song or video within the list and play it to hear the song or view the video, (4) The ability for the viewer, public, etc to select to “BUY” the song (once this is selected, a pop-up “shopping” cart will appear. The item(s) is placed into the cart and when the viewer is done, he or she can purchase the songs and or videos using an account with HitStems or other payment services and or credit card and instantly receive a download of the song or video to computer or device, (5) The ability for the viewer, public, etc to “REMIX” the song and or video, (by selecting this option, the viewer, public, etc. . . . will be presented with a pop-up window containing the HitStems site whereby each of the PARTS are broken out in a project timeline, ready for the viewer, public, etc to remix, add to, take away, etc to create their own song. (They will follow the process as described above and pay the royalties as described should they choose to purchase the song that they have created), (6) The ability to “SHARE” the songs, whereby when this option is selected, a pop-up window will appear, allowing the viewer, public, etc to enter email addresses, IM addresses, chat addresses and other forms of communication to which that particular HitStems player, containing all of the available songs and or videos will be sent to that recipient. Upon opening that communication, the HitStems player will be presented in full functionality to the recipient.

The payment for the down load of the song and or video using the “BUY” button may at times be less than the sum of the royalties attached to each PART. If this is the case, the proceeds will be divided PRO-RATA to the owners of the PARTS. Processing fees may apply, which will affect the amount available for distribution to the owners of the PARTS.

In some embodiments the user is provided with the ability to upload pre-recorded audio and or video files into the song being created and have it become part of the song.

In some embodiments the user is provided with the ability to tag the sing-along, play-along, uploaded audio or video files with necessary information so that it can be used within the system to create other songs, etc., including but not limited to: name of stem, loop or beat; name of artist, name of album, bpm, key, length (number of notes), royalty fee, date created, keywords, description, etc.

In some embodiments a user that exclusively takes stems from others and no original content may elect a Produce Song option. In such option the user can arrange or rearrange a song and charge a royalty for example a $0.50 Producer Royalty for the song arrangement.

In some embodiments a user is not allowed to download a song unless at least three (3) purchased instrument tracks and or three purchased stems are included in the song.

In other embodiments a user is allowed to download a single stem but at a higher price.

In some embodiments the system will auto-detect (using currently available technologies such as or similar to Shazam from Shazam Entertainment of the United Kingdom. This auto-detect is employed when someone attempts to upload a song for distribution. If it is not recognized upload will proceed. If it is recognized upload will not proceed. In the event that certain portions or stems are recognized, then the system will confirm whether the user has purchased the rights and whether the upload fill includes the royalty attribution information necessary to track rights to use of the stem in the uploaded song. If the file does the upload will be allowed. If not the recognized portion will be flagged and upload will not be allowed and the user will be notified of the flagged portions that have blocked allowance of the upload.

In some embodiments of the system when the user us in try mode described above, or is using a song or stem that has not been purchased, a click track is presented. The only means the user has to hear or record the content without the click track is to only use purchased songs and stems.

In

Throughout the embodiment discussed above reference has been made to Stems for the sake of this application stems could also include loops, sounds, effects, samples, beats and other audio segments or portions of audio segments.

FIG. 25 illustrates a preferred special purpose workstation 600 for using the system described herein. The workstation 600 includes one or more displays 602 for presenting information to users and for accepting information input if the display is a touch screen or employs a digitizer for such purpose. It also my include a alphanumeric keyboard 604 for entering text. Various inputs and outputs 606 for receiving and sending audio and or video signals. It may also include various other hardware inputs 610, 612 and 614 that have various mechanical input controls. The system may also include hardware devices or be connected to hardware devices to which the distributed or purchased audio can be recorded or copied into various tangible formats for later and repeated replay.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims.

What is claimed is:

1. A system for creation of music that:
allows the purchase of both integrated songs and individual separately manipulatable song stems;
allows the manipulation of multiple stems to produce creative musical content;
while tracking the royalty attributable to each stem;
allows the purchase of the new creation as an integrated song;
allows the new creation to be release for purchase by others in an integrated form using the royalty attribution of the songs stem content.
